(19) United States
(12) Patent Application Publication
(10) Pub. No.: US 2018/0191774 A1
(43) Pub. Date: Jul. 5, 2018

(54) METHOD AND SYSTEM FOR SHUNTING REFLECTIVE DDOS TRAFFIC

(71) Applicant: GUANGDONG EFLYCLOUD COMPUTING CO., LTD., Foshan City (CN)

(72) Inventors: Runqiang LIANG, Foshan City (CN); Guowen ZHANG, Foshan City (CN); Yanqing YANG, Foshan City (CN); Meixia YE, Foshan City (CN); Zhilai GUAN, Foshan City (CN)

(73) Assignee: GUANGDONG EFLYCLOUD COMPUTING CO., LTD., Foshan City (CN)

(21) Appl. No.: 15/858,006

(22) Filed: Dec. 29, 2017

(30) Foreign Application Priority Data
Dec. 29, 2016 (CN) 201611242165.5

(51) Int. Cl. H04L 29/06; G06F 21/55

(52) U.S. Cl. CPC H04L 63/1458; G06F 21/554; H04L 63/1416; H04L 63/1425

(57) ABSTRACT

Disclosed are a method and system for shunting reflective DDOS traffic. The method includes: acquiring and detecting data flow of a network node A to obtain an attack source IP address and a set of attack types (Set T) where the attack source IP address generates attack traffic of which the type belongs to the set of attack types (Set T); sending the attack source IP address and the set of attack types (Set T) to a drainage device; sending, by the drainage device, all requests for the set of attack types (Set T) to the attack source IP address; and draining attack traffic sent by the attack source IP address to a network node B where the attack traffic is cleaned. The attack source IP address is an IP address of a base server utilized by a hacker.

### CROSS-REFERENCE TO RELATED APPLICATIONS

This application claims priority to Chinese patent application No. 201611242165.5 filed on Dec. 29, 2016, the disclosure of which is incorporated herein by reference in its entirety.

### TECHNICAL FIELD

The present disclosure relates to network technologies, and in particular, to a method and system for shunting reflective DDOS traffic.

### BACKGROUND

At present, regardless of whether to cope with ordinary Distributed Denial of Service (DDOS) attacks or reflective DDOS attacks, a traffic cleaning device is necessary to deploy in front of a protected end to use an active detection and passive traction & cleaning method. This method has a very big defect in that once traffic is formed and reaches a transmission link of the protected end, the cleaning can only play a part of role. That is, if the traffic is not enough to congest the network transmission, this cleaning method is somewhat effective; but if the traffic is large enough to congest the network transmission, this cleaning method is little effective. Generally, the reflective DDOS attack traffic can have more than tens of Gbps, but common data centers and small operators have no sufficient bandwidth to transmit such the huge amount of traffic.

There is also another cleaning solution that the cleaning device is deployed at each transmission source end of the network to clean up the attack traffic sent by each source end. This method for cleaning the source end can clean the traffic at the point where the attack traffic is sent, and has a very significant effect on preventing the formation of the large attack traffic. However, there is also a drawback in that, the cost of this cleaning method is very high in deployment and network complexity is also relatively large.

### SUMMARY

The present disclosure is to provide a method and a system for shunting reflective DDOS traffic. According to the present disclosure, by actively sending a request to the utilized base server to drain and draw traffic of the base server, the number of attack requests sent by the attacker to the base server to be process is reduced, thus indirectly reducing the traffic sent by the base server to an attacked target to achieve an effect of shunting a reflective traffic.

For this purpose, the present disclosure adopts the following technical solutions:

A method for shunting reflective DDOS traffic, including:

data flow of a network node A is acquired and detected to obtain an attack source Internet protocol (IP) address and a set of attack types (Set T), where the attack source IP address generates attack traffic of which the type belongs to the set of attack types (Set T);

the attack source IP address and the set of attack types (Set T) are sent to a drainage device;

all requests for the set of attack types (Set T) are sent to the attack source IP address by the drainage device;

the attack traffic sent by the attack source IP address is drained to a network node B where the attack traffic is cleaned;

the attack source IP address is an IP address of the base server utilized by a hacker.

Further, a bandwidth of the network node A is narrower than a bandwidth of the network node B.

Further, the data flow of the base server is acquired by an optical splitter or a port mirroring, and the data flow is detected through algorithm analysis and policy matching so as to obtain the attack source IP address and the set of attack types (Set T).

A shunt reflective DDOS traffic system includes a detection device, a drainage device, and a cleaning device.

The detection device is configured to acquire and detect data flow of a network node A to obtain an attack source Internet protocol (IP) address and a set of attack types (Set T), and send the attack source IP address and the set of attack types (Set T) to a drainage device, where the attack source IP address generates attack traffic of which the type belongs to the set of attack types (Set T);

The drainage device is configured to send all requests for the set of attack types (Set T) to the attack source IP address;

The cleaning device is configured to drain the attack traffic sent by the attack source IP address to a network node B where the attack traffic is cleaned.

Further, a bandwidth of the network node A is narrower than a bandwidth of the network node B.

Further, the detection device is deployed at the network node A, and the drainage device and the cleaning device are both deployed at the network node B.

Further, the detection device acquires the data flow of the base server by an optical splitter or a port mirroring, and detects the data flow through algorithm analysis and policy matching so as to obtain the attack source IP address and the set of attack types (Set T).

The attack source IP address is an IP address of the base server utilized by a hacker. The data flow of the network node A is acquired and detected, to directly obtain the attack source IP address and the set of attack types (Set T), and then the attack source IP address and the set of attack types (Set T) are sent to the drainage device. The drainage device in this embodiment includes several normal servers, so that it is convenient to operate, has no strict requirements on the network architecture and deployment, and hence is easy to be deployed and the cost can be controlled effectively.

All requests for the set of attack types (Set T) are sent to the attack source IP address by the drainage device; and attack traffic sent by the attack source IP address is drained to a network node B where the attack traffic is cleaned.

All the requests for the set of attack types (Set T) are actively sent to the utilized base server, to drain and draw the traffic of the base server. Because total traffic sent by the base server is generally constant and the capacities of the base server is also limited, by sending a request to the base server, the number of attack requests sent by the attacker to be processed by the base server is reduced, thus indirectly reducing the attack traffic sent by the base server to the attacked target so as to achieve the effect of shunting the reflective DDOS traffic, and to avoid transmission congestion caused by the network node A where the attacked target is located.

### BRIEF DESCRIPTION OF THE DRAWINGS

FIG. 1 is a flowchart of a method for shunting reflective DDOS traffic according to one embodiment of the present disclosure; and

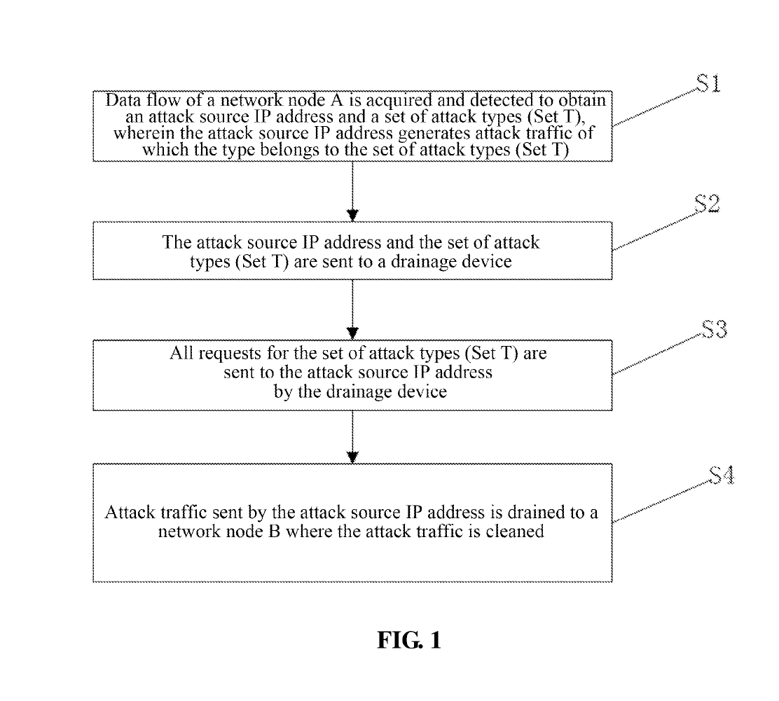

FIG. 2 is a schematic diagram of a system for shunting reflective DDOS traffic according to one embodiment of the present disclosure.

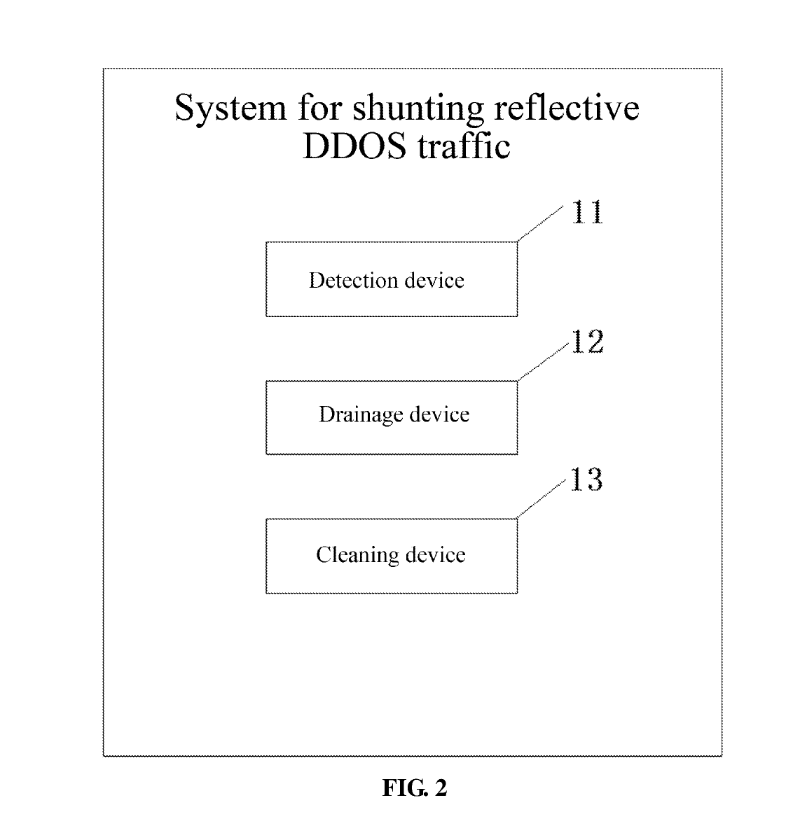

where in the figures: Detection Device 11, Drainage Device 12, and Cleaning Device 13.

### DETAILED DESCRIPTION

The technical solution of the present disclosure will be further described below with reference to the accompanying drawings and through specific embodiments.

A method for shunting reflective DDOS traffic, including:

Step 1 (S1): data flow of a network node A is acquired and detected to obtain an attack source Internet protocol (IP) address and a set of attack types (Set T), wherein the attack source IP address generates attack traffic of which the type belongs to the set of attack types (Set T);

Step 2 (S2): the attack source IP address and the set of attack types (Set T) are sent to a drainage device 12;

Step 3 (S3): all requests for the set of attack types (Set T) are sent to the attack source IP address by the drainage device 12;

Step 4 (S4): the attack traffic sent by the attack source IP address is drained to a network node B where the attack traffic is cleaned.

In this embodiment, the set of attack types (Set T) includes attacks for Network Time Protocol (ntp), Simple Service Discovery Protocol (ssdp), and Domain Name System (dns). These attack types are commonly seen, and apparently the set of attack types (Set T) may be other attack types in other embodiments.

In this embodiment, the attack source IP address is an IP address of the base server utilized by a hacker. The data flow of the network node A is acquired and detected to directly obtain the attack source IP address and the set of attack types (Set T), and then the attack source IP address and the set of attack types (Set T) are sent to the drainage device 12. The drainage device 12 in this embodiment includes several normal servers, so that it is convenient to operate, has no strict requirements on the network architecture and deployment, and hence is easy to be deployed and the cost can be controlled effectively.

All the requests for the set of attack types (Set T) are sent to the attack source IP address by the drainage device 12; and the attack traffic sent by the attack source IP address is drained to the network node B where the attack traffic of which the type belongs to the set of attack types (Set T) is cleaned.

All the requests for the set of attack types (Set T) are actively sent to the utilized base server, to drain and draw the traffic of the base server. Because total traffic sent by the base server is generally constant and the capacities of the base server is also limited, by sending a request to the base server, the number of attack requests sent by the attacker to be processed by the base server is reduced, thus indirectly reducing the attack traffic sent by the base server to the attacked target so as to achieve the effect of shunting the reflective DDOS traffic, and to avoid transmission congestion caused by the network node A where the attacked target is located.

Further, a bandwidth of the network node A is narrower than a bandwidth of the network node B.

In this way, the network node B with sufficient bandwidth resources may be used to protect the network node A with less bandwidth resources, so as to reduce the possibility of transmission congestion at the network node A.

Further, at step S1, the data flow of the network node A is acquired by an optical splitter or a port mirroring, and the data flow is detected through algorithm analysis and policy matching to obtain the attack source IP address and the set of attack types (Set T).

A shunt reflective DDOS traffic system includes a detection device 11, a drainage device 12, and a cleaning device 13.

The detection device 11 is configured to acquire and detect the data flow of the network node A to obtain an attack source Internet Protocol (IP) address and a set of attack types (Set T), and send the attack source IP address and the set of attack types (Set T) to the drainage device 12, where the attack source IP address generates attack traffic of which the type belongs to the set of attack types (Set T).

The drainage device 12 is configured to send all the requests for the set of attack types (Set T) to the attack source IP address.

The cleaning device 13 is configured to drain the attack traffic sent by the attack source IP address to the network node B where the attack traffic is cleaned.

In this embodiment, the attack source IP address is an IP address of the base server utilized by a hacker. The data flow of the network node A is acquired and detected to directly obtain the attack source IP address and the set of attack types (Set T), and then the attack source IP address and the set of attack types (Set T) are sent to the drainage device 12. The drainage device 12 in this embodiment includes several normal servers, so that it is convenient to operate, has no strict requirement on the network architecture and deployment, and hence is easy to be deployed and the cost can be controlled effectively.

All the requests for the set of attack types (Set T) are sent to the attack source IP address by the drainage device 12; and the attack traffic sent by the attack source IP address is drained to the network node B where the attack traffic is cleaned.

All the requests for the set of attack types (Set T) are actively sent to the utilized base server, to drain and draw the traffic of the base server. Because total traffic sent by the base server is generally constant and the capacities of the base server is also limited, by sending a request to the base server, the number of attack requests sent by the attacker to be processed by the base server is reduced, thus indirectly reducing the attack traffic sent by the base server to the attacked target so as to shunt the reflective DDOS traffic, and to avoid transmission congestion caused by the network node A where the attacked target is located.

Further, a bandwidth of the network node A is narrower than a bandwidth of the network node B.

In this way, the network node B with sufficient bandwidth resources may be used to protect the network node A with less bandwidth resources, so as to reduce the possibility of transmission congestion at the network node A.

Further, the detection device 11 is deployed at the network node A, and the drainage device 12 and the cleaning device 13 are both deployed at the network node B.

Because the network node A has less bandwidth resources, the detection device 11 is deployed at the network node A, and hence the network node B with sufficient bandwidth resources may be used to protect the network node A with less bandwidth resources.

Further, the detection device 11 acquires the data flow of the network node A by an optical splitter or a port mirroring, and detects the data flow through algorithm analysis and policy matching in order to obtain the attack source IP address and the set of attack types (Set T).

The technical principle of the present disclosure has been described above with reference to specific embodiments. These descriptions are merely for the purpose of explaining the principles of the disclosure and are not to be construed as limiting the scope of the disclosure in any way.

What is claimed is:

1. A method for shunting reflective Distributed Denial of Service (DDOS) traffic, comprising:
acquiring and detecting data flow of a network node A to obtain an attack source Internet Protocol (IP) address and a set of attack types (Set T), wherein the attack source IP address generates attack traffic of which the type belongs to the set of attack types (Set T);
sending the attack source IP address and the set of attack types (Set T) to a drainage device;
sending all requests for the set of attack types (Set T) to the attack source IP address by the drainage device; and
draining the attack traffic sent by the attack source IP address to a network node B where the attack traffic is cleaned,
wherein the attack source IP address is an IP address of a base server utilized by a hacker.

2. The method for shunting reflective DDOS traffic according to claim 1, wherein
a bandwidth of the network node A is narrower than a bandwidth of the network node B.

3. The method for shunting reflective DDOS traffic according to claim 1, wherein
the data flow of the base server is acquired by an optical splitter or a port mirroring, and the data flow is detected through algorithm analysis and policy matching so as to obtain the attack source IP address and the set of attack types (Set T).

4. A system for shunting reflective DDOS traffic, comprising:
a detection device;
a drainage device; and
a cleaning device,
wherein,
the detection device is configured to acquire and detect data flow of a network node A to obtain an attack source Internet protocol (IP) address and a set of attack types (Set T), and send the attack source IP address and the set of attack types (Set T) to a drainage device, wherein the attack source IP address generates attack traffic of which the type belongs to the set of attack types (Set T);
the drainage device is configured to send all requests for the set of attack types (Set T) to the attack source IP address; and
the cleaning device is configured to drain the attack traffic sent by the attack source IP address to a network node B where the attack traffic is cleaned.

5. The system for shunting reflective DDOS traffic according to claim 4, wherein
a bandwidth of the network node A is narrower than a bandwidth of the network node B.

6. The system for shunting reflective DDOS traffic according to claim 5, wherein
the detection device is deployed at the network node A, and the drainage device and the cleaning device are both deployed at the network node B.

7. The system for shunting reflective DDOS traffic according to claim 4, wherein
the detection device acquires the data flow of the base server by an optical splitter or a port mirroring, and detects the data flow through algorithm analysis and policy matching so as to obtain the attack source IP address and the set of attack types (Set T).
